(19) United States
(12) Patent Application Publication
(10) Pub. No.: US 2007/0194655 A1
(43) Pub. Date: Aug. 23, 2007

(54) Automotive AC generator designed to establish shaft-to-shaft connection with engine

(75) Inventor: Hiroyuki Ogi, Tajimi-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/705,120

(22) Filed: Feb. 12, 2007

(30) Foreign Application Priority Data
Feb. 22, 2006 (JP) 2006-045364

(51) Int. Cl. F16D 3/28; H02K 7/10; H02K 5/16

(52) U.S. Cl. 310/261; 310/90; 310/75 R; 464/70

(57) ABSTRACT

An automotive AC generator is provided which includes a rotary shaft and a generator connector jointed to the rotary shaft. The generator connector is designed to establish a mechanical connection between the rotary shaft and a motor connector joined to a drive shaft of the motor for transmitting the drive torque to the rotary shaft. The generator connector is placed to establish eccentricity between an axis thereof and an axis of the motor connector at all times during rotation of the rotary shaft, thereby resulting in a radial load acting on bearings of the rotary shaft in one direction so as to keep a total load on the bearings greater than zero (0) at all the time. This avoids the seizing of the bearings and creeping of a bearing holder.

### CROSS REFERENCE TO RELATED DOCUMENT

The present application claims the benefit of Japanese Patent Application No. 2006-45364 filed on Feb. 22, 2006, the disclosure of which is incorporated herein by reference.

### BACKGROUND OF THE INVENTION

1. Technical Field of the Invention

The present invention relates generally to an improved structure of an automotive AC generator designed to establish a shaft-to-shaft joint with an engine through, for example, a yoke pulley.

2. Background Art

Typical automotive AC generators or alternators are designed to be supplied with power from the engine to charge a storage battery or feed electric power to an ignition system of the engine, an in-vehicle lighting system, an in-vehicle air conditioner, an audio system, or other electric components. In recent years, an increased number of devices for augment the comfort of the vehicle or devices designed to meet a variety of regulations such as emission regulations have been mounted on the engine or within the engine compartment. However, there is the need for ensuring spaces within the engine compartment to absorb physical impacts arising from vehicle collisions in order to assure the safety for vehicle occupants, thus resulting in the need for arranging the devices within the engine compartment at high density. The same is true for accessories mounted on the engine. Particularly, the alternators are smaller in size than the other accessories and connected electrically to the body of the engine through flexible wires, so that they have a higher degree of freedom in installation thereof within the engine compartment. The alternators may, therefore, be placed deep within the engine compartment in a shaft-to-shaft connection with the engine. In this case, the alternator is usually disposed in alignment of a rotary shaft with a drive shaft joined to the engine, so that the radial load acting on bearings retaining a rotor of the alternator will be extremely small. This may result in seizing of the bearings arising from a lack of lubricant caused by the slip of rolling elements on rolling contact surfaces of races or creep between a bearing holder and the outer race of the bearing, thus leading to the wear of the bearing within a housing of the alternator. In order to minimize the slip of the rolling elements of the bearing, Japanese Patent First Publication No. 2001-27246 teaches deforming the outer race of the bearing slightly to create a plurality of small gaps between the outer race and the rolling elements each time the outer race or the inner race makes a 360-degree turn, thereby inducing self-rotation of the rolling elements when passing the gaps.

In order to avoid the creep of the bearing holder, Japanese Patent First Publication No. 11-294469 teaches installing an elastic member such as resin or spring in a groove formed in the outer race of the bearing to elastically create friction between the outer race and the bearing holder to hold the outer race from rotating.

The former structure requires the need for controlling the configuration of the inner and outer races, that is, the size of the small gaps accurately, thus resulting in an increased difficulty in machining the bearing and an increased production cost of the bearings. Additionally, the size of the gaps depends upon the ambient temperature, therefore, such bearings are unsuitable for the alternators.

The latter structure is complicate, so that the elastic member fitted on the outer race will cause a disturbance to insertion of the bearing into the bearing holder, thus resulting in increases in assembling steps and production cost of the alternator.

### SUMMARY OF THE INVENTION

It is therefore a principal object of the invention to avoid the disadvantages of the prior art.

It is another object of the invention to provide an improved structure of an automotive AC generator designed to minimize the seizing or creep of bearings without sacrificing production costs and assembling workability thereof.

According to one aspect of the invention, there is provided an AC generator which may be employed in automotive vehicles. The AC generator comprises: (a) a rotary shaft which is to be rotated by drive torque transmitted from a motor to rotate a rotor to generate AC power; and (b) a generator connector jointed to the rotary shaft. The generator connector is designed to establish a mechanical connection between the rotary shaft and a motor connector joined to a drive shaft of the motor for transmitting the drive torque to the rotary shaft. The generator connector is placed to establish eccentricity between an axis thereof and an axis of the motor connector at all times during rotation of the rotary shaft to exert a physical load on the rotary shaft in a given direction.

In the preferred mode of the invention, the AC generator also includes a bearing retaining the rotary shaft to be rotatable and an elastic member installed on one of the generator connector and the motor connector. The elastic member is elastically deformed by eccentric rotation of the generator connector and the motor connector to exert the physical load on the bearing as a radial load oriented in a radial direction of the bearing.

The distance by which the axis of the generator connector is eccentric from the axis of the motor connector may be so selected that when a dynamic load, as produced depending upon the rotor, acts on the bearing, a combination of the radial load and the dynamic load is applied to the bearing at all times only from a preselected direction.

Specifically, the eccentricity between the generator connector and the motor connector results in the radial load acting on the bearing in one direction so as to keep a total load on the bearing greater than zero (0) at all the time. This avoids the seizing or creeping of the bearing.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows the structure of an alternator according to the invention;

FIG. 2 is a partially exploded view which shows a joint between the alternator of FIG. 1 and a coupling of a drive shaft connected to an engine;

FIG. 3 is a longitudinal sectional view which shows an example of a conventional alternator with a yoke pulley being in alignment with a coupler of a drive shaft;

FIG. 4 is a longitudinal sectional view which shows an example of a conventional alternator designed to be driven through a belt;

FIG. 5(a) is a view which represents a static load Ps acting on bearings of each of the alternators of FIGS. 1, 3, and 4;

FIG. 5(b) is a view which represents a dynamic load Pf acting on bearings of each of the alternators of FIGS. 1, 3, and 4;

FIG. 5(c) is a view which represents a total load Po acting on bearings of each of the alternators of FIGS. 1, 3, and 4; and

FIG. 6 is a graph which shows a relation between repulsive force, as produced by an elastic damper installed on a yoke pulley of an alternator, and an eccentric distance between the yoke pulley and a coupler of a drive shaft.

### DESCRIPTION OF THE PREFERRED EMBODIMENT

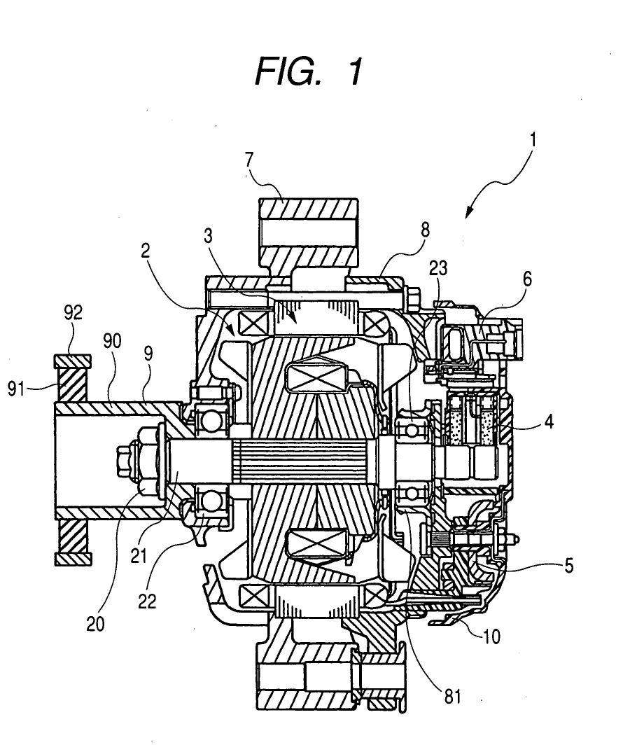

Referring to the drawings, wherein like reference numbers refer to like parts in several views, particularly to FIG. 1, there is shown an AC generator or alternator 1 for automotive vehicles according to the invention which is illustrated, as an example, as having a cooling fan built therein.

The alternator 1 consists essentially of a rotor 2, a stator 3, a brush unit 4, a rectifier device 5, an IC regulator 6, a drive frame 7, a rear frame 8, a yoke pulley 9, and a rear cover 10. The rotor 2 has a rotary shaft 21 retained at ends thereof by bearings 22 and 23 to be rotatable.

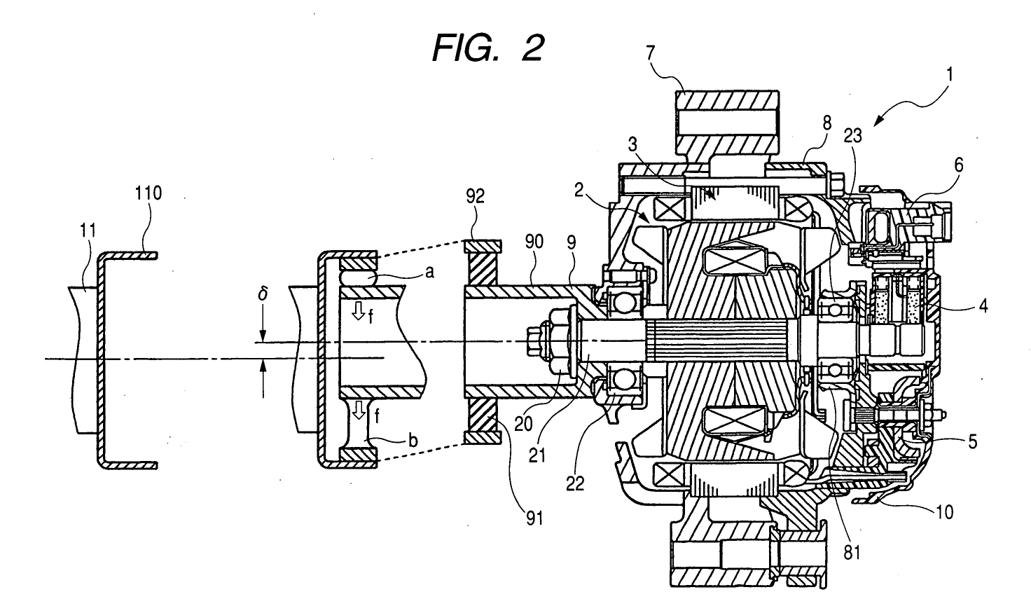

FIG. 2 is a sectional view which illustrates a joint between a drive shaft 11 and the yoke pulley 9 of the alternator 1. The yoke pulley 9 is made up of a hollow first cylinder 90, a second cylinder 92, and an annular elastic damper 91 made of, for example, rubber. The first cylinder 90 is joined to the shaft 21 of the rotor 2 tightly through a nut 20. The second cylinder 92 is fitted on the periphery of the first cylinder 90 through the elastic damper 91 for engagement with the inner periphery of a coupler 110 joined to the end of the drive shaft 11. Specifically, the joint of the drive shaft 11 and the alternator 11 is achieved with the coupler 110 and the yoke pulley 9.

The coupler 110 (i.e., the drive shaft 11) is in misalignment with the yoke pulley 9. Specifically, the center or axis of the coupler 110 (i.e., the longitudinal center line of the drive shaft 11) is shifted or eccentric from the center or axis of the yoke pulley 9 by a given distance δ (>0). This causes the elastic damper 91 of the yoke pulley 9 to undergo compression in an upper angular range a and expansion in a lower angular range b, as viewed in FIG. 2, so that the repulsive force f, as produced by the elastic damper 91, acts on the yoke pulley 9.

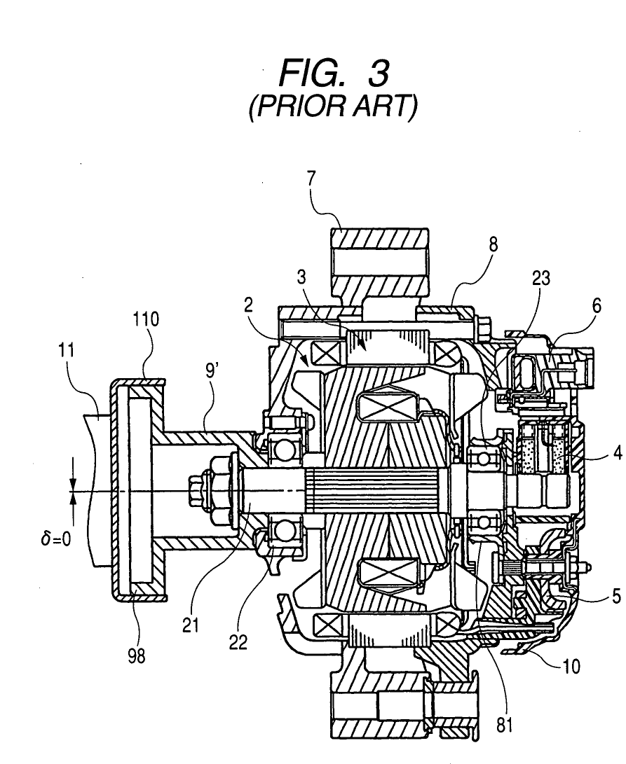

FIG. 3 demonstrates an example of a conventional alternator having a yoke pulley 9′ joined to the drive shaft 11. The yoke pulley 9′ is in alignment with the drive shaft 11. Specifically, the distance 6 by which the center of the coupler 110 of the drive shaft 1 1 is eccentric from a front flange 98 of the yoke pulley 9′ is zero (0), so that no radial pressure (i.e., the repulsive force f) acts on the yoke pulley 9′.

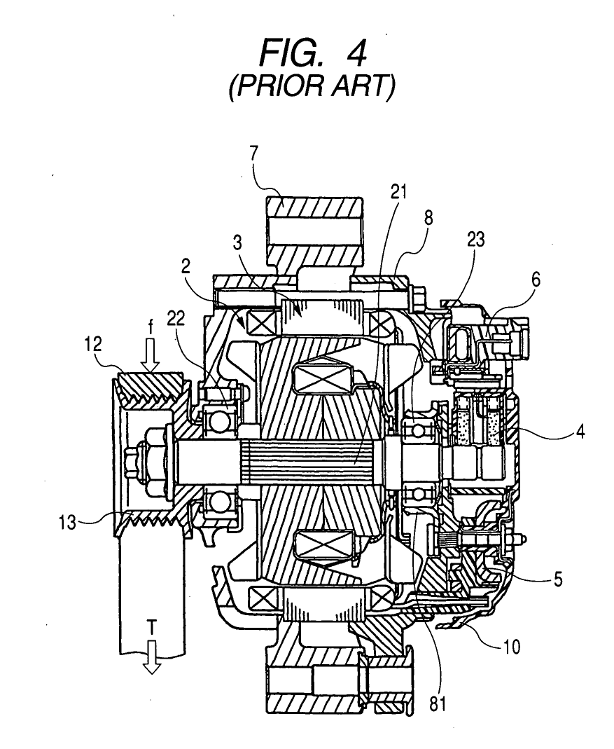

FIG. 4 demonstrates another example of a conventional alternator equipped with a belt-drive mechanism. The alternator has a V-grooved pulley 13 around which a belt 12 is wrapped while being subjected to a given degree of tension T in dynamic engagement with a crank pulley, an idler, or other devices. The V-grooved pulley 13 is subjected to tension f transmitted from the belt 12, so that a resulting load oriented in one direction is transmitted to the bearings 22 and 23 through the shaft 21.

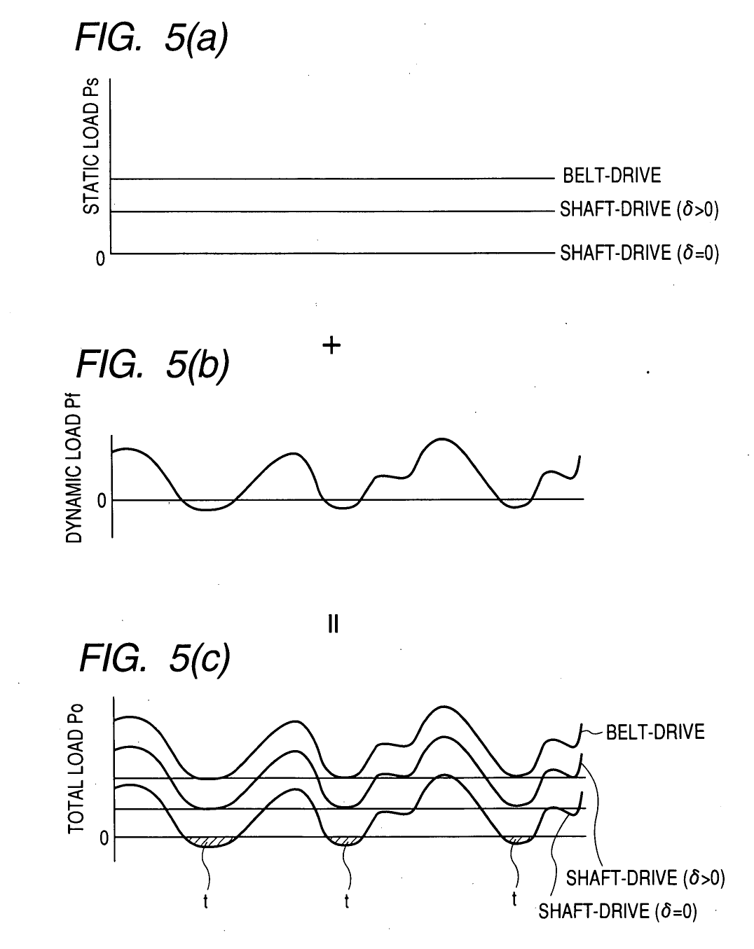

FIGS. 5(a), 5(b), and 5(c) demonstrate physical loads acting on the bearings 22 and 23 of the shaft 21 of three types of alternators: the shaft-driven alternator 1 of this embodiment equipped with the yoke pulley 9 being in misalignment with the drive shaft 11, the shaft-driven alternator of FIG. 3 with the yoke pulley 9′ being in alignment with the drive shaft 11, and the belt-driven alternator of FIG. 4. FIG. 5(a) represents the static load Ps acting on the bearings 22 and 23 of each of the alternators. FIG. 5(b) represents a dynamic load Pf acting on the bearings 22 and 23 of each of the alternators. FIG. 5(c) represents a total load Po (i.e., the sum of Ps and Pf) acting of the bearings 22 and 23 of each of the alternators.

The static load Ps added to the bearing 22 and 23 depends upon the external force facting on the pulley 9, 9′, or 13 and have the value different between the belt-driven alternator of FIG. 4 and the shaft-driven alternator 1 of this embodiment. Specifically, the value of the static load Ps acting on the belt-driven alternator is the greatest in the three. The value of the static load Ps acting on the shaft-driven alternator of this embodiment is middle in the three. The value of the static load Ps acting on the shaft-driven alternator of FIG. 3 is zero (0). The dynamic load Pf varies, as illustrated in FIG. 5(b), and is defined by a load parameter P1, as determined by the vibration (g) acting on the mass (m) of the rotor 2, and a load parameter P2 depending upon an unbalance in rotation of the rotor 2 as a function of the speed of the rotor 2.

The total load Po acting on the bearings 22 and 23 of each of the alternators is a combination of the static load Ps and the dynamic load Pf and varies, as illustrated in FIG. 5(c). Specifically, the total load Po on the belt-driven alternator is oriented in one direction at all the time. The total load Po on the shaft-driven alternator of FIG. 3 is affected by the dynamic load Pf, so that it becomes zero (0) at a time t and is reversed in orientation thereof. This causes the bearings 22 and 23 to undergo irregular radial loads, which leads to concerns about the seizing of the bearing 22 arising from a lack of grease resulting from sliding of rolling elements of the bearing 22 or the creeping wear of the bearing holder 81 of the bearing 23 resulting from a change in orientation of the load on the bearing 23.

The shaft-driven alternator 1 of this embodiment is so designed that the static load Ps that is greater than required to cancel the dynamic load Pf is applied to the bearings 22 and 23, thereby causing the total load Po to be kept oriented in a given direction, like the belt-driven alternator of FIG. 4, to avoid the premature seizing of the bearing 22 and the creeping wear of the bearing holder 81, as described above.

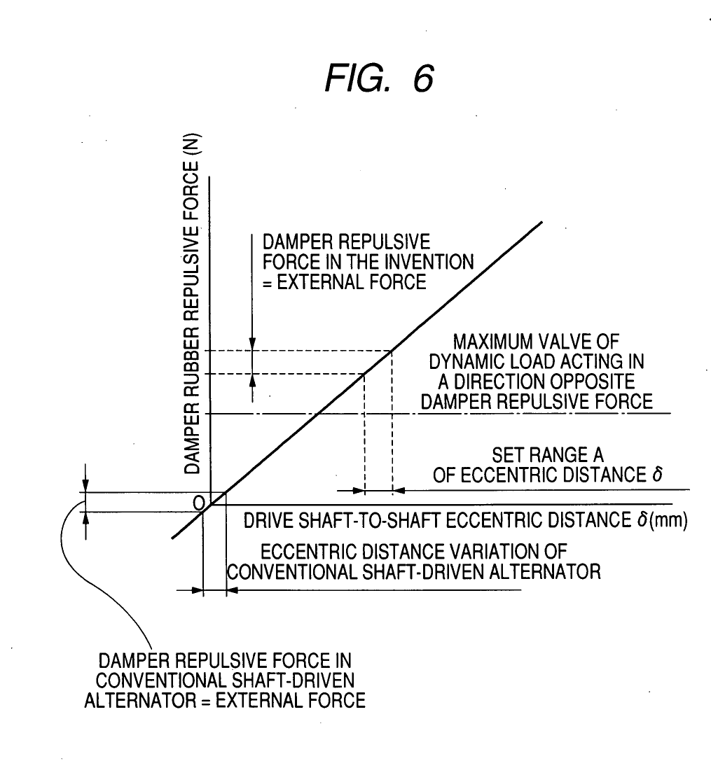

FIG. 6 shows the repulsive force, as produced by a damper rubber. When the yoke pulley 9 is, as illustrated in FIG. 2, arranged eccentrically from the drive shaft 11 in the radial direction thereof by the distance 6, as selected within an eccentric distance range, as specified in FIG. 6, the repulsive force f, as produced by the elastic damper 91, is transmitted to the bearings 22 and 23 through the yoke pulley 9 and the shaft 21 and acts on the bearings 22 and 23 as desired radial loads which do not become zero (0) at all times.

Specifically, the eccentricity of the yoke pulley 90 from the coupler 110 (i.e., the drive shaft 11) results in the radial loads acting on the bearings 22 and 23 in one direction so as to keep the total load Po on the bearings 22 and 23 greater than zero (0) at all the time. This avoids the seizing of the bearings 22 and 23 and the creep of the bearing holder 81 without the needs for improving the accuracy in machining the bearings 22 and 23 and for installation of elastic members on the outer races of the bearings 22 and 23 which will increase the production cost of the alternator 1 and complicate the assembling of the alternator 1.

The eccentric distance δ is so selected based on the mechanical property of the elastic damper 91 as to keep above zero (0) at all times the total load Po, which is a combination of the dynamic load Pf and the radial load produced as a function of the eccentric distance δ, acting on the bearings 22 and 23 from one direction, thereby avoiding the seizing of the bearings 22 and 23 and the creep of the bearing holder 81.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For example, the elastic damper 91 may alternatively be attached to the coupler 110 of the drive shaft 11. An additional damper equivalent to the elastic damper 91 may also be installed to the coupler 110 of the drive shaft 11.

What is claimed is:

1. An automotive AC generator comprising:
a rotary shaft which is to be rotated by drive torque transmitted from a motor to rotate a rotor to generate AC power; and
a generator connector jointed to said rotary shaft, said generator connector being designed to establish a mechanical connection between said rotary shaft and a motor connector joined to a drive shaft of the motor for transmitting the drive torque to said rotary shaft, said generator connector being placed to establish eccentricity between an axis of said generator connector and an axis of the motor connector at all times during rotation of said rotary shaft to exert a physical load on said rotary shaft in a given direction.

2. An automotive AC generator as set forth in claim 1, further comprising a bearing retaining said rotary shaft to be rotatable and an elastic member installed on one of the generator connector and the motor connector, said elastic member being elastically deformed by eccentric rotation of the generator connector and the motor connector to exert the physical load on said bearing as a radial load oriented in a radial direction of said bearing.

3. An automotive AC generator as set forth in claim 2, wherein a distance by which the axis of said generator connector is eccentric from the axis of the motor connector is so selected that when a dynamic load, as produced depending upon the rotor, acts on the bearing, a combination of the radial load and the dynamic load is applied to the bearing at all times only from a preselected direction.
